(19) United States
(12) Patent Application Publication
(10) Pub. No.: US 2016/0112473 A1
(43) Pub. Date: Apr. 21, 2016

(54) METHOD FOR REAL-TIME COMMUNICATION BETWEEN WEB BROWSERS

(71) Applicant: ORANGE, Paris (FR)

(72) Inventors: Miguel Labranche, Bonneuil Sur Marne (FR); Xavier De Snoeck, Paris (FR)

(73) Assignee: ORANGE, Paris (FR)

(21) Appl. No.: 14/891,283

(22) PCT Filed: May 16, 2014
(86) PCT No.: PCT/FR2014/051145

§ 371 Date: Nov. 13, 2015

(30) Foreign Application Priority Data
May 17, 2013 (FR) 1354444

(51) Int. Cl. H04L 29/06; H04L 12/58; H04M 3/53; H04L 29/08; H04M 3/533

(52) U.S. Cl. CPC H04L 65/403; H04L 67/02; H04L 67/10; H04M 3/533; H04L 65/1069; H04L 67/24; H04M 3/5307; H04M 3/5322; H04L 51/04

(57) ABSTRACT

The invention relates to a real-time communication method using WebRTC type technology between web browsers on an Internet type communications network, the method comprising: a first web browser of a first terminal associated with a first user previously loading (S20) a web application provided by an application server, the web application providing real-time communication functions between web browsers; and the first browser sending (S21) a call setup request, via the web application, to the application server, which call setup request includes an identifier of a user being called, referred to as the “second” user.

The method is remarkable in that it further comprises steps of:
determining (S22, S23, S24) an availability state of the second user for answering the call setup request; and
automatically redirecting (S25) to a web address of a messaging service associated with the second user when the second user is not available.

The invention relates in general manner to real-time communication between web browsers on a communications network such as the Internet.

More precisely, the invention relates to the technology for real-time communication between web browsers as currently being standardized jointly by the World Wide Web Consortium (W3C) and the Internet Engineering Task Force (IETF), under the names web real-time communication (WebRTC) for W3C, and RTCWEB for IETF.

Recent years have seen a new platform emerge for developing services based on so-called “web applications”, i.e. applications that are downloaded by a browser when consulting a web page, namely: the web browser. Specifically, once the browser platform has the interfaces needed for operating with such web applications, it is possible to deliver almost any kind of service via a browser.

Conventionally, the above-mentioned interfaces are supplied to the browser in the form of extension modules, commonly referred to as “plugins”, suitable for being downloaded and then installed separately from the browser.

As examples of real-time communication (RTC) web services between browsers that are available on the market, mention may be made of products known under the names Skype™, Facebook™ (which uses Skype), and Google Hangouts™ (which uses the Google Talk™ plugin). Mention may also be made of the Flash Player™ product from the supplier Adobe.

All of the above-mentioned products require downloading, native applications, or extension modules (i.e. plugins) external to the browser. Unfortunately, downloading, installing, and updating plugins is complex to do, a source of errors, and a source of inconvenience. Furthermore, designing, testing, updating, and deploying plugins is complex and expensive.

With the development of the hypertext markup language 5 (HTML5), new perspectives are becoming available to applications developers with the possibility of making applications programming interfaces (APIs) with web applications available in standardized manner within a browser.

This is the path being followed by IETF and W3C in the RTCWEB/WebRTC standard, which seeks to provide two types of specification:
a protocol specification, provided by IETF; and
a specification for Javascript APIs, provided by W3C.

The two above-mentioned specifications seek to provide an environment in which a Javascript application that is incorporated in any web page, then read by any compatible browser, and authorized in appropriate manner by its user, is capable of setting up communication making use of audio, video, and auxiliary data, without any need for the browser platform to limit the types of application in which this communication function can be used.

In the present RTCWEB/WebRTC standard, a web browser needs to implement three API interfaces in order to be capable of receiving and transmitting data in streaming mode (sometimes also referred to as “continuous reading” or “stream broadcasting”), which APIs are the following:
MediaStream: enables the browser to access data streams such as those coming from a webcam or a microphone of the user's terminal;
RTCPeerConnection: provides audio and video calls, with mechanisms for encryption and bandwidth management; and
RTCDataChannel: provides peer-to-peer communication of generic data.

In order to obtain more information about the RTCWEB/WebRTC specifications, it is possible to consult the following documents in particular:
WebRTC 1.0: Real-time communication between browsers—W3C editor's draft Mar. 22, 2013—available on the Internet at the following address:

http://dev.w3.org/2011/webrtc/editor/webrtc.html#rtc peerconnection-interface
Overview: Real-time protocols for browser-based applications—draft-ietf-rtcweb-overview-06-Feb. 20, 2013—accessible on the Internet at the following address:

http://datatracker.ietf.org/doc/draft-ietf-rtcweb-overview/

At present, web browser publishers are proposing experimental versions of this new service between browsers, for example Google with the Chrome™ browser, Mozilla with the Firefox™ browser, Ericsson with the browser known as Bowser™ that has been developed for mobile telephones.

In the presently-proposed versions, which comply with the RTCWEB/WebRTC specifications, when a first user seeks to set up an audio or video communication from that user's web WebRTC compatible web browser to a second user on the Internet, the first user begins by using the browser to connect to an application server that provides the WebRTC communication service. After a possible authentication operation, the browser uses a web page to load the web application (Javascript application) complying with the RTCWEB specifications and adapted to interact with the above-mentioned APIs (complying with the WebRTC specifications) that are natively incorporated in the browser.

Thereafter, using the web page connecting with the application server, the first user selects an identifier for the second user and then enters a command—e.g. a click on an action button displayed in the web page open in the browser—in order to launch the audio or video call to the second user. Typically, the web page opened in the browser then displays a message indicating that the connection is being set up.

If the second user, to whom the call is being made, is also connected to the same WebRTC communication service provided by the application server, then that user can accept the audio or video call coming from the first user, and communication can then be set up.

Otherwise, when the browser on the second user's terminal is not active, or when the web page of the WebRTC service is not open in the second user's browser, or indeed if the second user's terminal is not connected to the network, then the audio or video communication between the first and second users cannot be set up, and the first user is not informed about the reason for the failure of the communication.

A particular object of the present invention is to remedy the above-mentioned situation. To this end, in a first aspect, the invention provides a real-time communication method in compliance with WebRTC type technology, between web browsers on a communications network of the Internet type.

The term “WebRTC type” technology is used to mean real-time communication technology between web browsers based on the same principles as those defined by the RTCWEB/WebRTC specifications, i.e. based on standard web browsers, without it being necessary to add extension modules (i.e. plugins) to those browsers.

According to the invention, the above method comprises:
a first web browser of a first terminal associated with a first user previously loading a web application provided by an application server, the web application providing real-time communication functions between web browsers; and
the first browser sending a call setup request, via the web application, to the application server, which call setup request includes an identifier of a user being called, referred to as the “second” user.

In accordance with the invention, the method further comprises the following steps:
determining an availability state of the second user for answering the call setup request; and
automatically redirecting to a web address of a messaging service associated with the second user when the second user is not available.

Thus, in the invention, when the second user is determined as being unavailable to answer the call, the first user's browser is redirected automatically to a web address (i.e. a uniform resource locator (URL)) of a messaging service, which means that the first user is not left without any information about the failure of the communication.

Thus, in the invention, if the request to set up a call does not succeed by the end of a duration determined in the first browser, e.g. as measured by a timer, the first user's browser is redirected automatically to a web address (i.e. a uniform resource locator (URL)) of a messaging service, which means that the first user is not left without any information about the failure of the communication.

In an implementation of the invention, the step of determining an availability state of the second user includes evaluating a lapse of time since the call setup request was sent, with the availability state of the second user then being determined as being unavailable once the elapsed time reaches a determined duration.

In another implementation, which may be combined with the preceding implementation, the step of determining an availability state of the second user includes obtaining presence information about the second user for the real-time communication service between browsers, and if the presence information indicates that the second user is absent for the service, then the availability state of the second user is determined as being unavailable.

In practice, in an implementation, obtaining presence information involves consulting a presence table for users of the real-time communication service between web browsers.

Thus, when the WebRTC communication service manages a presence state of subscribers to the service, if the second user is determined as being absent for the communication service at the time the call request is sent by the first user, then the first browser's browser is immediately redirected to the web address of the messaging service.

In particular, according to a characteristic of the invention, as a result of being redirected to the messaging service, the first browser displays a web page playing back a message from the second user.

In practice, the message played back from the second user may be a message of audio, video, and/or text type.

Thus, after redirection to the messaging service, the first user is informed by means of the message from the second user that the second user is not reachable and possibly with reasons why the second user is not reachable.

Furthermore, according to an additional characteristic of the invention, the web page, which is displayed in the first browser and which plays back the message from the second user, also provides the first user with an option of leaving a message for the second user.

In various implementations, this message for the second user may be a message of audio, video, and/or text type.

Thus, in the context of WebRTC communication between browsers, such a messaging service of the invention can not only provide a service similar to that provided in the context of conventional telephony (i.e. mobile or fixed), but it can also do so with additional options concerning the types of message that can be left.

According to a particular characteristic of the invention, as a result of a message being left by the first user, the message that has been left is transmitted by the first browser to a messaging server, the messaging server subsequently transmitting a notification to a terminal associated with the second user to indicate that the message left by the first user has been received.

In a particular implementation of the invention, the above-specified notification is a message of the short message service (SMS) type or of the multimedia messaging service (MMS) type transmitted to a mobile telephony identifier associated with the second user. Provision may also be made for the notification to comprise an email transmitted to an email address of the second user. Depending on the implementation in question, the notification may also consist in simultaneously sending a plurality of messages of different types corresponding to distinct communications terminals (PC, mobile telephone, . . . ) used by the second user.

It is also possible to envisage using a message waiting indicator (MWI) as a notification.

In practice, depending on the selected implementation, the above-mentioned notification may include some or all of the following information:
the identity of the caller;
the type of message left (audio, video, text, . . . );
the duration of the message;
the number of characters used in the message (text message);
whether or not the message is urgent.

In this way, even if not connected to the Internet or not connected to the messaging server of the invention, the second user can be warned of the arrival of a message from a user who has attempted to reach the second user by WebRTC communication.

In a first implementation of the communication method of the invention, the steps of determining the time that has elapsed since sending a call setup request, and of automatic redirection to a voice messaging service once the elapsed time has reached a determined duration, are performed by the web application loaded in the first browser. In this implementation, the web application is typically a Javascript application incorporated in the HTML code of the web page provided by the application server offering the real-time communication service between browsers.

This first implementation is particularly adapted to the situation in which the provider of the real-time communication service between browsers also provides the associated WebRTC messaging service, or when the provider of the real-time communication service between browsers provides only the function of redirection to a WebRTC messaging server managed by a third party service provider.

In a second implementation, said steps of determining the time that has elapsed since sending a call setup request, and of automatic redirection to a voice messaging service, are performed by a programming interface (API) natively incorporated in the first browser.

This second implementation is adapted to the situation in which the provider of the real-time communication service between browsers and the provider of the associated messaging service are distinct entities. The API implementing the messaging service in the browser then enables the user of the browser to set the web address (URL) of the messaging service that is to be opened by the browser in the event of there being no answer from the destination browser when attempting to set up a call.

Correspondingly, in a second aspect, the invention consequently provides a web application providing real-time communication functions between web browsers. This web application of the invention comprises program instructions that, on being executed by a processor on triggering by a web browser of a communications terminal, causes steps to be performed for determining the time that has elapsed since sending a call setup request, and for redirecting to a voice messaging service when the elapsed time reaches a determined duration, in accordance with a communication method as set out briefly above.

Consequently, such a web application is particularly adapted to the above-mentioned first implementation.

In a third aspect, the invention also provides a web browser including a programming interface (API) including computer program code, that on being executed by a processor of a communications terminal in which the web browser is installed, causes steps to be performed for determining the time that has elapsed since sending a call setup request, and for redirecting to a voice messaging service when the elapsed time reaches a determined duration, in accordance with the communication method of the invention, as set out briefly above.

Consequently, such a browser is particularly adapted to the second above-mentioned implementation.

Finally, in fourth and fifth aspects respectively, the present invention also provides:
a messaging server accessible by a web browser via a web address, the messaging server providing a messaging service for implementing a communication method of the invention as set out above; and
an application server providing a real-time communication service between web browsers, the application comprising a web server hosting at least one web page including a web application in accordance with the second above-mentioned aspect of the invention.

In a particular implementation of the invention, the messaging server may be included in the application server of the invention.

Other characteristics and advantages of the present invention appear from the following detailed description, which refers to the accompanying drawings, in which:

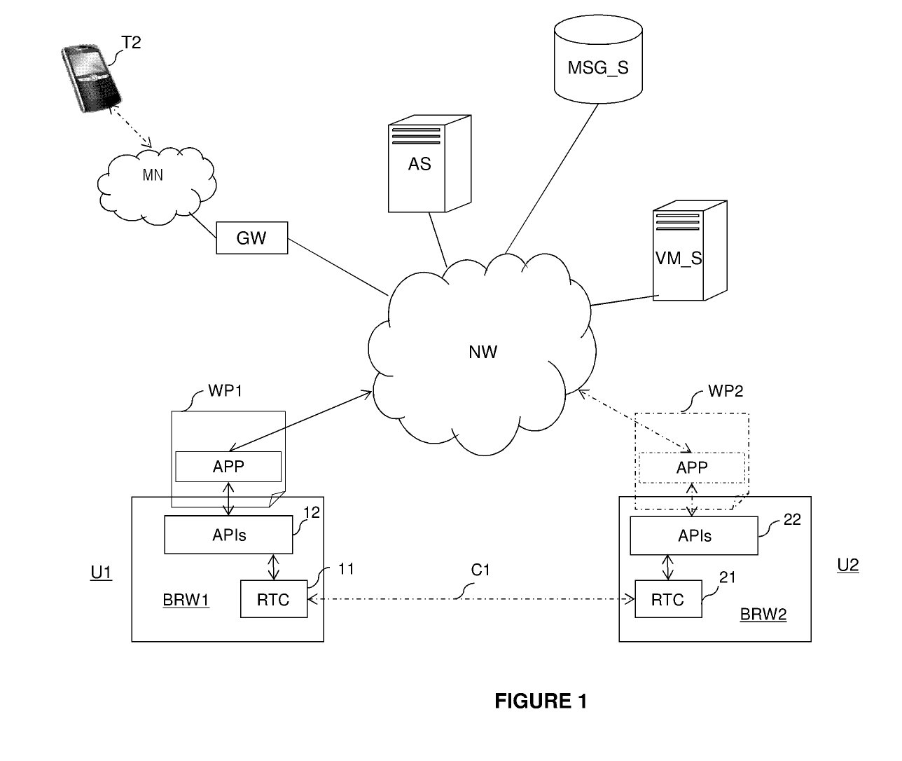

FIG. 1 shows a network environment in which the present invention can be implemented;

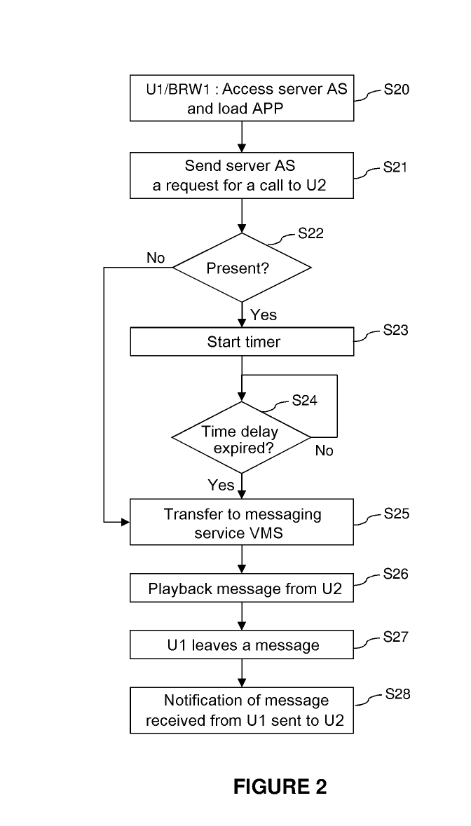

FIG. 2 is a flow chart showing the main steps of the communication method of the invention;

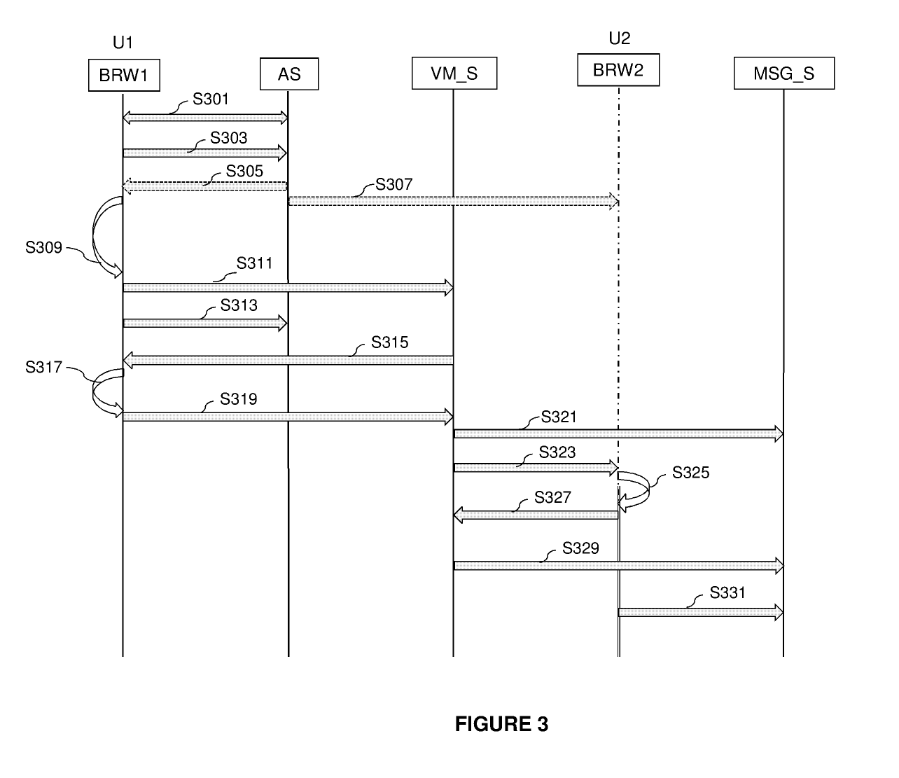

FIG. 3 is a diagram showing the exchanges between the various entities shown in FIG. 1 in an implementation of a communication method of the invention;

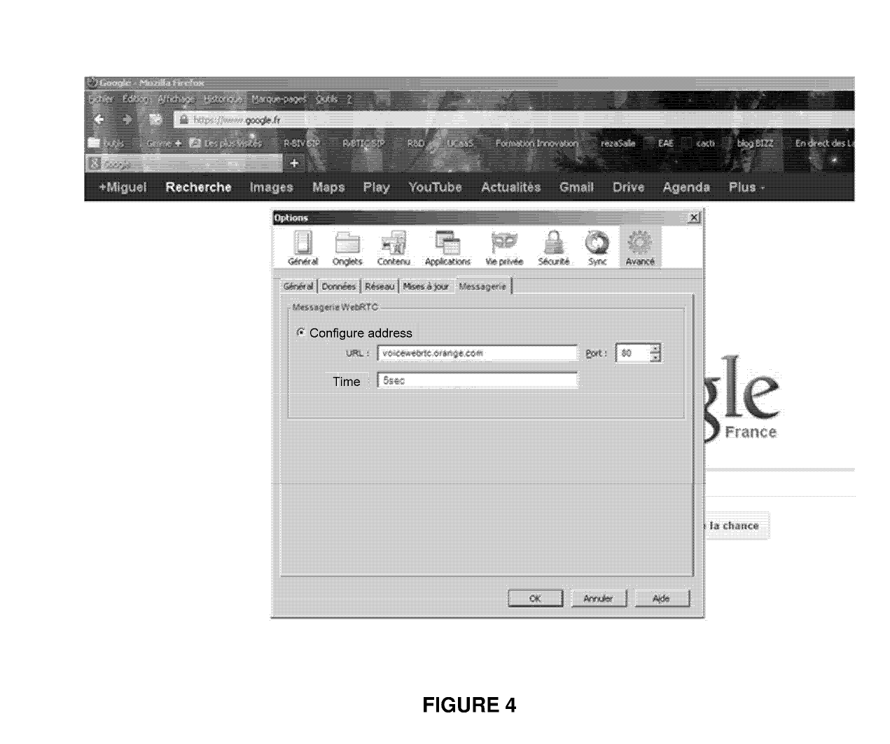

FIG. 4 shows a dialog box open in a browser for setting the redirection address to a messaging service and the timeout before redirection, in an implementation of the invention;

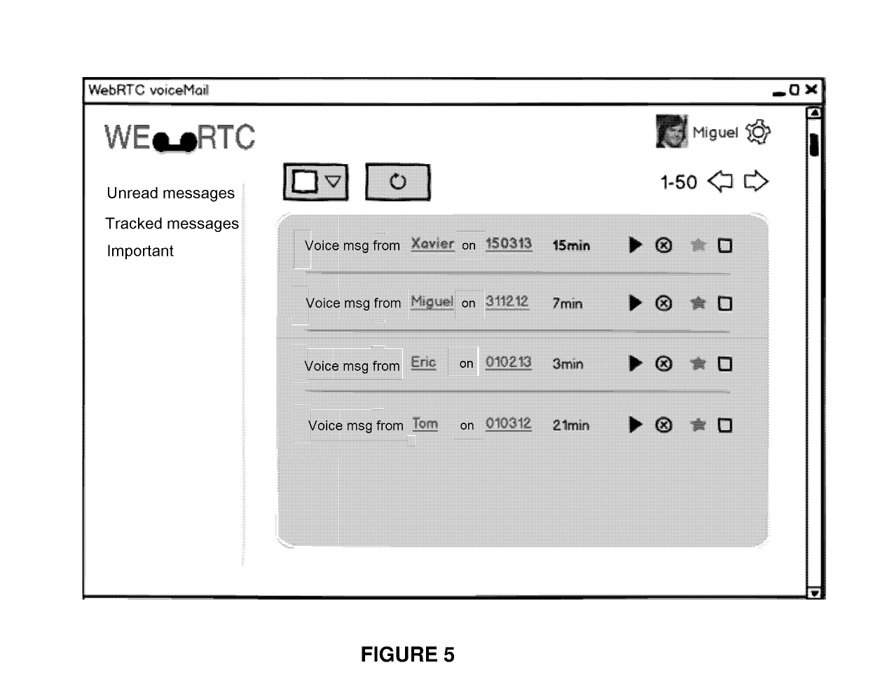

FIG. 5 shows an example of a graphics interface obtained by a user's browser after connecting to a WebRTC messaging server of the invention, enabling the user to consult the messages received;

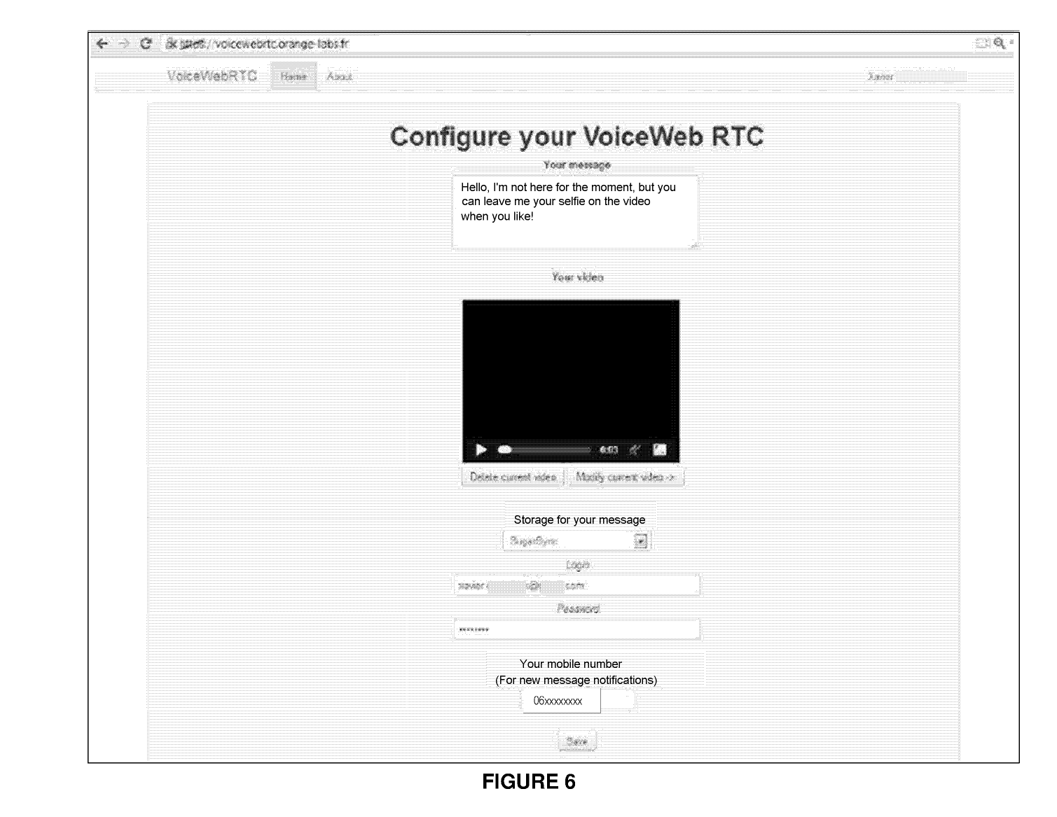

FIG. 6 shows an example of a graphics interface obtained by a user's browser after connecting with a WebRTC messaging server of the invention, in order to enable the user to configure the user's own messaging service; and

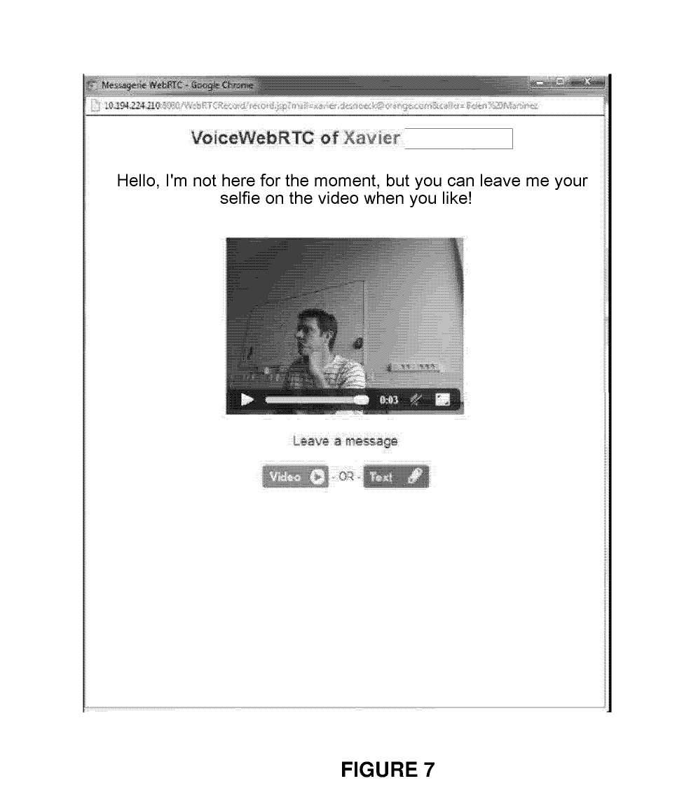

FIG. 7 shows an example of a graphics interface obtained by a first user's browser after being redirected to a WebRTC messaging server of the invention after receiving no answer to a call made to a second user.

FIG. 1 shows a network environment in which the present invention can be implemented.

The environment shown comprises a first web browser BRW1 of a first user terminal (belonging to user U1), and a second browser BRW2 of a second user terminal (belonging to user U2). The above-mentioned user terminals may be in a connected or a non-connected state relative to a communications network NW which is an Internet type network, i.e. a network based on the communications technologies implemented in the Internet, and in particular the network NW may be a business network, commonly known as an intranet.

The browsers BRW1 and BRW2 are web WebRTC/RTCWEB-compatible browsers, and they thus have respective sets 12, 22 of API interfaces in compliance with the WebRTC specifications, and respective RTC function modules 11, 21 in compliance with the RTCWEB specifications. The API sets 12 and 22 are respectively suitable for interacting with a Javascript application APP incorporated in web pages WP1 and WP2 downloaded respectively by the browsers BRW1 and BRW2 from a web address of resources hosted by an application server AS on the network NW.

In compliance with the WebRTC/RTCWEB specifications, the application APP provides RTC communication functions, in particular relating to access to the WebRTC real-time communication service supplied by the server AS, and to the signaling that makes it possible to set up such communication between browsers.

Thus, in the example shown in FIG. 1, if both browsers BRW1 and BRW2 have each downloaded the web page (WP1, WP2) containing the WebRTC service application APP, then they can set up peer-to-peer real-time communication, C1, in particular communication of the voice or video type.

In contrast, if the browser BRW1 attempts to set up a call with the terminal in which the browser BRW2 is installed, and if that terminal is off or is not connected to the server AS and has not opened the web page WP2 of the service, or indeed if the corresponding terminal is not connected to the network or if the user (U2) of the terminal simply does not respond to the call, then the communication C1 cannot be set up between the two browsers BRW1 and BRW2 (which is why the web page WP2 and the double-headed arrow C1 are shown using chain-dotted lines).

Still with reference to FIG. 1, there can also be seen a WebRTC messaging server VM_S of the invention associated with a message storage server MSG_S—that have respective roles that are described in greater detail in the description below—, and a mobile terminal T2 associated with the user (U2) of the second browser, and connected to a mobile telephony network MN of the second, third, or fourth generation (2G, 3G, or 4G), itself connected to a gateway GW enabling the mobile network MN to be connected to the network NW.

Reference is made to FIG. 2, which is a flow chart representing the main steps of a communication method of the invention as implemented in an environment of the kind shown in FIG. 1.

During a step S20, the browser BRW1 of the user U1 accesses a web address of a WebRTC service as supplied by the application server AS. After a possible stage of authentication with the service, the browser loads the web page WP1 containing the Javascript application APP.

In the following step S21, the browser BRW1 uses the RTCPeerConnection API to sent to the server AS a request to set up a call to the user U2.

Sending the call setup request triggers test step S23 for determining whether the second user is present for the WebRTC service. By way of example, this test is implemented by sending a command to a presence server in which a presence table for users who have subscribed to the WebRTC service is regularly updated. If the second user is determined as being absent (S22, “no”) for the WebRTC service, then the browser BRW1 is automatically redirected (step S25) to a WebRTC messaging web address hosted by the messaging server VMS. Otherwise, if the second user is determined as being present for the WebRTC service, then the method moves on to timing step S23 in order to determine the time that has elapsed since the call setup request was sent.

It should be observed that in the selected implementation, the step (S23) is performed for testing whether the second user is present, however if such presence information cannot be obtained, then the step S23 of starting a timer is executed directly.

In following step S24, the time that has elapsed since the call setup request was sent is tested. So long as the elapsed time has not reached a determined duration, then the browser continues to wait (S24, “no”). In the selected implementation, the duration of the timeout may be set in advance by the user U1 of the browser BRW1 (in particular when the invention is implemented at API level), or else it may be set by the service provider using the Javascript application APP.

During step S24, if the connection is set up with the destination browser BRW2, then step S24 is interrupted and communication (FIG. 1, C1) is set up with the destination browser BRW2.

In contrast, if the elapsed time reaches the determined time duration, then the call setup request is interrupted and the browser BRW1 is automatically redirected (step S25) to a WebRTC messaging web address hosted by the messaging server VMS.

A web page coming from the messaging service is then displayed by the browser BRW1, with this web page then playing back (step S26) a message previously recorded by the call destination user (user U2), in the same manner as with a conventional telephone answering machine. However this message may advantageously be recorded in various forms as selected by the user (U2): an audio, video, or text message, an audio and text message, or a video and text message.

The messaging web page displayed by the browser BRW1 of the user U1 also gives the user U1 the option of leaving a message (step S27), which message may likewise be in various forms: audio, video, or text message, audio and text message, or video and text message.

Finally, after the user U1 has left a message, the messaging server VM_S acts in a step S28 to send a notification to a communications terminal (PC, mobile or fixed telephony terminal, . . . ) associated with the second user (U2), indicating that the message left by the first user (U1) has been received.

In the presently-described implementation, the terminal(s) associated with the second user U2 to which a message-received notification is sent, (including the type of the notification) may be configured beforehand by the second user setting parameters associated with that user's messaging service, as managed by the messaging server. For example, the user U2 may configure the service so that such a notification is sent to a mobile telephony identifier belonging to that user U2, thereby enabling the user U2 to receive the notification in the form of an SMS or an MMS text message on the terminal T2.

FIG. 3 is a diagram shown the exchanges between the various entities shown in FIG. 1 in an implementation of the communication method of the invention.

As shown in FIG. 3, exchanges take place between the various entities described with reference to FIG. 1: the two browsers BRW1 and BRW2, the application server AS, the messaging server VM_S, and the message storage server MSG_S. The vertical line corresponding to the browser BRW2 is initially drawn as a chain-dotted line to indicate that the browser BRW2 is not active relative to the RTC communication service provided by the server AS—either because the browser is not connected to the server AS, or because it is not running in the associated terminal, or indeed that the terminal itself is not connected to the network NW.

In the first implementation as described above, the functions of determining the time that has elapsed since sending a call setup request, and of automatic redirection to a voice messaging service when the elapsed time reaches a determined duration, are performed by the web application loaded in a browser together with the web page provided by the application server AS.

In practice, the web application (APP, FIG. 1) is a Javascript application, and in this embodiment it may be enriched by a function of the type defined by the following pseudo-code, which is given by way of example:

```
    SetTimeout  (function( ))  {
    If call not answered then Redirect to URL_MES with
the parameters (called party identifier (email address,
etc.)
    }
```

Thus, in this implementation, if, starting from the launching of the call, a duration (as defined by the SetTimeout function) has elapsed without the called party answering, then the browser is automatically redirected to the address URL_MES of the messaging service together with a parameter, and in particular the identifier of the called party as used for making the call, e.g. an email address.

In the selected implementation, other information may be included as parameters during the redirection operation, e.g. the type of terminal being used by the calling user (U1).

In the second implementation described above, the time that has elapsed since a request was sent for setting up a call, and the automatic redirection to a voice messaging service, are both performed by an API programming interface incorporated natively in the browsers. In practice, the new functions provided by the present invention are implemented in the RTCPeerConnection API interface.

More precisely, in compliance with the WebRTC/RTCWEB specifications, when setting up a WebRTC communication between two browsers, messages are exchanged using an offer/answer model in the context of the session description protocol (SDP).

In this context, in the second implementation, provision is made to modify the RTCPeerConnection API interface by including a new function herein referred in this example as “SetRedirectionMevo(noanswer)” (bold below), for redirection to a messaging service in the event of no answer from the called browser, with this including recovering the identifier of the called party, and where appropriate other information, in order to enable messages to be left on the called party's messaging service:

```
Caller transition:
      new PeerConnection( ): stable
      setLocal(offer): have-local-offer
      SetRedirectionMevo(no answer): caller has no answer from
callee
      setRemote(pranswer): have-remote-pranswer
      setRemote(answer): stable
      close( ): closed
```

To order to obtain more information concerning the RTCPeerConnection interface, it is possible to consult the following document: WebRTC 1.0: Real-time communication between browsers—W3C editor's draft Mar. 22, 2013; at the following web address:

http://dev.w3.org/2011/webrtc/editor/webrtc.html#rtc peerconnection-interface

(in particular, see section 4.4.1 RTCPeerState Enum).

In this implementation, the browsers BRW1 and BRW2 are previously configured by their respective users, so as to set the messaging address to which the browser is to be redirected in the event of the called party not answering, together with the duration of the waiting time for an answer from the called party, beyond which redirection is to be performed.

The configuration of a browser in this implementation is illustrated by FIG. 4 which shows a dialog box open in a browser for the purpose of setting the address for redirecting to a messaging service and for setting the timeout before redirection. In FIG. 4, it can be seen that the redirection web address (URL) is “voicewebrtc.orange.com” on port 80, and that the timeout is set at 5 seconds.

Furthermore, each user subscribing to the WebRTC service of the invention begins by configuring a personal messaging service, either directly with the messaging server VM_S, or indirectly via the application server AS. This prior configuration consists in particular firstly in recording one or more messages (voice, video, and/or text) that are to be played back in the event of the user being unavailable for an incoming call, and secondly, where appropriate, in selecting storage space for storing, in particular, messages addressed to the user and coming from other users of the WebRTC service of the invention. This storage space may be hosted directly by the messaging server VM_S, or else by a dedicated storage server MSG_S, or indeed by a storage space specific to the user, e.g. by means of a subscription with some other service provider, such as for example Dropbox™ from the supplier Dropbox, or Le Cloud d′Orange™ from the supplier Orange. User configuration with providers of remote storage spaces is performed using specific API interfaces provided by those providers.

Returning to FIG. 3, in step S301, the user U1 of the browser BRW1 connects to the WebRTC service of the invention as provided by the server AS using a procedure that is specific to the service itself, which may include a user authentication operation. It is possible to envisage a procedure for connecting to the server AS of the same type as that made available by Facebook® using Facebook Connect APIs. This step includes the browser loading the web page containing the Javascript application of the WebRTC service.

Thereafter (step S303), the user U1 launches a call (e.g. a video call) via the browser to the user U2 of the browser BRW2, and receives in return (step S305) a text message in the browser of the user U1 indicating that the call is being set up. In parallel, the server AS attempts to reach the browser BRW2 in order to transmit the call request (step S307) thereto, but the browser BRW2 at that time is inactive (dashed line).

In the first browser BRW1, sending the call setup request starts the timeout step S309 in accordance with the invention. Once the waiting time has elapsed without the call being set up with the browser BRW2, during a step S311, the browser BRW1 is automatically redirected in accordance with the invention to the messaging server VM_S. Furthermore, the browser BRW1 transmits a command to the server AS to interrupt the current call (step S313).

In step S315, the browser BRW1 loads from the messaging server VM_S the web page that displays the “answering machine” of the user U2 for whom the failed call was intended, and automatically plays back the non-availability message from that user (e.g. a video message).

After playing back the non-availability message from the user U2, the user U1 acts during a step S317 to record a message for the user U2 (e.g. a voice message). Depending on the selected implementation, the step S317 makes use in particular of the MediaStream or getUserMedia API of the browser BRW1, or else a Javascript web application function contained in the web page provided by the messaging server VM_S, e.g. a WebRTC primitive named RecordRTC.

In the following step S319, the message recorded by the user U1 is transmitted to the messaging server VM_S. This server then forwards the message (step S321) to the message storage server MSG_S.

Thereafter, in step S323, the messaging server consults the configuration data for the messaging service of the user U2, and determines an identifier of the user U2 (or of a terminal, e.g. an IP address), and a notification format, in order to send a notification to the user U2 informing the user U2 of the arrival of a new message. In this example, the identifier is an email address, and when the user U2 connects to the network NW (step S325) using a terminal (e.g. a PC), the user can then consult the email message and become aware of the notification message.

In step S327, the user U2 makes a connection via the browser BRW2—e.g. by clicking on a URL link present in the notification message—to the messaging server VM_S, so as to read the new message. Using an identifier of the user U2 and by connecting (step S329) to the storage server MSG_S, the user VM_S updates a messaging graphics interface associated with the user U2 with the links (URLs) giving access to new messages.

Finally, in step S331, the user U2 can click on corresponding links in the messaging interface displayed by the browser (BRW2), in order to cause new messages to be played back in streaming mode, and in particular the message left by the user U1.

Examples of graphic interfaces obtained by connecting a web browser to a WebRTC messaging server of the invention are shown with reference to FIGS. 5 to 7.

FIG. 5 shows an example of a graphics interface obtained by a browser of a user after connecting to a WebRTC messaging server of the invention, enabling the user to consult messages that have been received. In this example, only voice messages are shown.

FIG. 6 shows an example of a graphics interface obtained by a browser of a user after connecting to a WebRTC messaging server of the invention, for the purpose of enabling the user to configure that user's personal messaging service. In this example, only a text answer message has been configured by the user.

FIG. 7 shows an example of an interface, e.g. a graphics interface obtained by a browser of a first user after redirection to a WebRTC messaging server of the invention, as a result of there being no answer to a call made to a second user.

In the interface shown, there can be seen the absence text message from the second user: “Hello ( . . . ) video when you like”; and beneath that a window displaying the video being recorded that corresponds to the message left by the first user.

1. A real-time communication method using WebRTC type technology between web browsers on an Internet type communications network, the method comprising:
a first web browser of a first terminal associated with a first user previously loading (S20) a web application provided by an application server, said web application providing real-time communication functions between web browsers; and
the first browser sending (S21) a call setup request, via said web application, to the application server, which call setup request includes an identifier of a user being called, referred to as the “second” user;
said method being characterized in that it further comprises the following steps:
determining (S22, S23, S24) an availability state of the second user for answering the call setup request; and
automatically redirecting (S25) to a web address of a messaging service associated with said second user when the second user is not available.

2. A method according to claim 1, wherein the step of determining an availability state of the second user includes evaluating (S23, S24) a lapse of time since the call setup request was sent, with the availability state of the second user then being determined as being unavailable once the elapsed time reaches a determined duration.

3. A method according to claim 1, wherein the step of determining an availability state of the second user includes obtaining (S22) presence information about the second user for the real-time communication service between browsers, and if said presence information indicates that the second user is absent for said service, then the availability state of the second user is determined as being unavailable.

4. A method according to claim 1, wherein, as a result of being redirected to said messaging service, the first browser displays a web page playing back a message from the second user.

5. A method according to claim 4, wherein the message played back from the second user is a message of audio, video, and/or text type.

6. A method according to claim 4, wherein said web page displayed in the first browser provides the first user with an option of leaving (S27) a message for the second user.

7. A method according to claim 6, wherein a message left by the first user is a message of audio, video, and/or text type.

8. A method according to claim 6, wherein, as a result of a message being left by the first user, the message that has been left is transmitted by the first browser to a messaging server, said messaging server subsequently transmitting (S28) a notification to a terminal associated with said second user to indicate that the message left by the first user has been received.

9. A method according to claim 8, wherein said notification comprises a message of the SMS or MMS type transmitted to a mobile telephony identifier associated with the second user.

10. A method according to claim 8, wherein said notification comprises an email transmitted to an email address of the second user.

11. A method according to claim 2, wherein said steps of determining the time that has elapsed since sending a call setup request, and of automatic redirection to a voice messaging service once the elapsed time has reached a determined duration, are performed by said web application loaded in the first browser.

12. A method according to claim 2, wherein said steps of determining the time that has elapsed since sending a call setup request, and of automatic redirection to a voice messaging service, are performed by a programming interface (API) natively incorporated in the first browser.

13. A web application providing real-time communication functions between web browsers, the application being characterized in that it includes program instructions that, on being executed by a processor on triggering by a web browser of a communications terminal, causes steps to be performed for determining the time that has elapsed since sending a call setup request, and for redirecting to a voice messaging service when the elapsed time reaches a determined duration, in accordance with a communication method using WebRTC type technology between web browsers on an Internet type communications network, the method comprising:
a first web browser of a first terminal associated with a first user previously loading (S20) a web application provided by an application server, said web application providing real-time communication functions between web browsers; and
the first browser sending (S21) a call setup request, via said web application, to the application server, which call setup request includes an identifier of a user being called, referred to as the “second” user;
said method being characterized in that it further comprises the following steps:
determining (S22, S23, S24) an availability state of the second user for answering the call setup request; and
automatically redirecting (S25) to a web address of a messaging service associated with said second user when the second user is not available.

14. A web browser characterized in that it includes a programming interface (API) including computer program code, that on being executed by a processor of a communications terminal in which the web browser is installed, causes steps to be performed for determining the time that has elapsed since sending a call setup request, and for redirecting to a voice messaging service when the elapsed time reaches a determined duration, in accordance with a communication method using WebRTC type technology between web browsers on an Internet type communications network, the method comprising:
a first web browser of a first terminal associated with a first user previously loading (S20) a web application provided by an application server, said web application providing real-time communication functions between web browsers; and
the first browser sending (S21) a call setup request, via said web application, to the application server, which call setup request includes an identifier of a user being called, referred to as the “second” user;
said method being characterized in that it further comprises the following steps:
determining (S22, S23, S24) an availability state of the second user for answering the call setup request; and
automatically redirecting (S25) to a web address of a messaging service associated with said second user when the second user is not available.

15. A messaging server accessible by a web browser via a web address, the server being characterized in that it provides a messaging service for performing a communication method using WebRTC type technology between web browsers on an Internet type communications network, the method comprising:
a first web browser of a first terminal associated with a first user previously loading (S20) a web application provided by an application server, said web application providing real-time communication functions between web browsers; and
the first browser sending (S21) a call setup request, via said web application, to the application server, which call setup request includes an identifier of a user being called, referred to as the “second” user;
said method being characterized in that it further comprises the following steps:
determining (S22, S23, S24) an availability state of the second user for answering the call setup request; and
automatically redirecting (S25) to a web address of a messaging service associated with said second user when the second user is not available.

16. An application server providing a real-time communication service between web browsers, the server being characterized in that it includes a web server hosting at least one web page including a web application providing real-time communication functions between web browsers, the application being characterized in that it includes program instructions that, on being executed by a processor on triggering by a web browser of a communications terminal, causes steps to be performed for determining the time that has elapsed since sending a call setup request, and for redirecting to a voice messaging service when the elapsed time reaches a determined duration, in accordance with a communication method using WebRTC type technology between web browsers on an Internet type communications network, the method comprising:
a first web browser of a first terminal associated with a first user previously loading (S20) a web application provided by an application server, said web application providing real-time communication functions between web browsers; and
the first browser sending (S21) a call setup request, via said web application, to the application server, which call setup request includes an identifier of a user being called, referred to as the “second” user;
said method being characterized in that it further comprises the following steps:
determining (S22, S23, S24) an availability state of the second user for answering the call setup request; and
automatically redirecting (S25) to a web address of a messaging service associated with said second user when the second user is not available.

17. An application server according to claim 16, including a messaging server accessible by a web browser via a web address, the server being characterized in that it provides a messaging service for performing the communication method.
